(19) United States
(12) Patent Application Publication
(10) Pub. No.: US 2003/0140750 A1
(43) Pub. Date: Jul. 31, 2003

(54) Device for trimming the edges of tape materials containing inserts

(76) Inventors: Bernd Hoffmann, Burgkunstadt (DE); Manfred Baer, Mainleus (DE)

Correspondence Address: JORDAN AND HAMBURG LLP, 122 EAST 42ND STREET, SUITE 4000, NEW YORK, NY, 10168, US

(21) Appl. No.: 10/305,772

(22) Filed: Nov. 26, 2002

(30) Foreign Application Priority Data
Jan. 15, 2002 (DE) 102 01 157.5-26

(51) Int. Cl. B26D 5/00

(52) U.S. Cl. 83/74; 83/433; 83/935

(57) ABSTRACT

A device for trimming edges of belt materials containing inserts, especially nylon or steel corded belts, by cutting off an edge region of the belt material with a cutting device, which engages the belt material between the inserts, extending in the longitudinal direction (cutting direction) of the belt and is held in a seat, suspended so that it can swivel at a framework transversely to the conveying direction, corresponding to the longitudinal direction of the belt, of the belt material passed by it, wherein the axis of rotation of the swinging suspension is disposed at a carriage, which can be moved by a motor transversely to the plane of swiveling and a device is provided, which detects the deflection of the pendulum and, when a specified value is exceeded, causes the carriage to move in the direction of deflection.

The invention relates to a device for trimming edges of belt materials containing inserts, especially nylon or steel belts, by cutting off an edge region of the belt material with a cutting device, which engages the belt material between the inserts, extending in the longitudinal direction (cutting direction) of the belt and is held in a seat, suspended so that it can swivel at a framework transversely to the conveying direction, corresponding to the longitudinal direction of the belt, of the belt material passed by it.

In the case of a cutting device of the aforementioned type, proposed in the DE 36 08 194 C2, the cutting knife, as seen from the central starting position, places itself to the left and to the right, in each case inclined V-shaped to the central knife position. As a result, the knife is no longer guided in the original parallel position between the inserts. Consequently, the danger is increased that, due to the inclined position of the knife in the cutting channel between two inserts, the knife is guided against an insert and exposes this insert there. However, this exposure of a textile or steel cord insert, which should remain covered by the belt material at all costs, must be avoided at all costs.

In order to achieve this, it has already been proposed in DE 44 11 937 C1 for a device of the type named above that the axis of rotation be disposed at such a vertical distance from the cutting plane of the cutting device that, when the seat and the cutting device are deflected from the vertical, the restoring forces are less than the deflection forces exerted by the inserts on the cutting device and affecting the guidance.

This method also is associated with difficulties in practice. It has namely turned out that, even with these safety measures, the edge trimming functions one hundred percent only if the cord material, which is to be cut, is supplied with a tolerance of about ±5 mm. If this tolerance is exceeded, the cutting device is inclined unusably and incorrect cuts result.

It is therefore an object of the invention to configure a device of the type above so that, even when the tolerances with regard to the position of the side edge are large when the cord material, which is to be cut, is supplied, an ideal cut, as centrally as possible between two inserts, is assured.

Pursuant to the invention, this objective is accomplished owing to the fact that the axis of rotation of the pendulum suspension is disposed at a carriage, which can be moved by a motor transversely in the plane of swiveling, and that a device is provided, which detects the deflection of the pendulum and, when a specified value is exceeded, causes the carriage to be shifted in the direction of deflection.

The inventive device makes the ideal trimming of the edges possible even when, due to non-uniform winding up of the cord material, the side edges occupy positions, which fluctuate greatly transversely to the conveying direction, since also the suspension for achieving slight restoring forces, proposed in the DE 44 11 937 C1, can of course function only to a limited extent within certain angles. After all, the restoring forces increase with increasing deflection and, at some time, simply become too large for preventing the exposure of the inserts during the cutting operation.

The inventive device prevents such inadmissible inclinations, in that the carriage, to which the axis of rotation of the pendulum is fixed, is simply moved in the direction of the inclined deflection. In the case of only a slight, permissible deflection, the knife is always guided centrally between two inserts, which extend curvilinearly, corresponding to the curvilinear deviation of the position of the side edge of the corded belt.

Aside from the expensive measuring devices for detecting the deflection of the pendulum, it has proven to be particularly simple and advantageous, in a development of the invention, if a cross arm, engaging between two adjustable sensors, is fastened to the pendulum suspension. As soon as the cross arm covers one of the two sensors, the carriage is displaced in the direction of the inclined deflection of the pendulum, in order to counteract this inclined deflection.

In this connection, it has proven to be particularly simple and appropriate in the manner of action, if the carriage is seated on a ball screw, which can be driven in both directions by a servomotor, so that the carriage can be moved merely by rotating the ball screw.

Further advantages, distinguishing features and details of the invention arise out of the following description of an example as well as from the drawing, in which

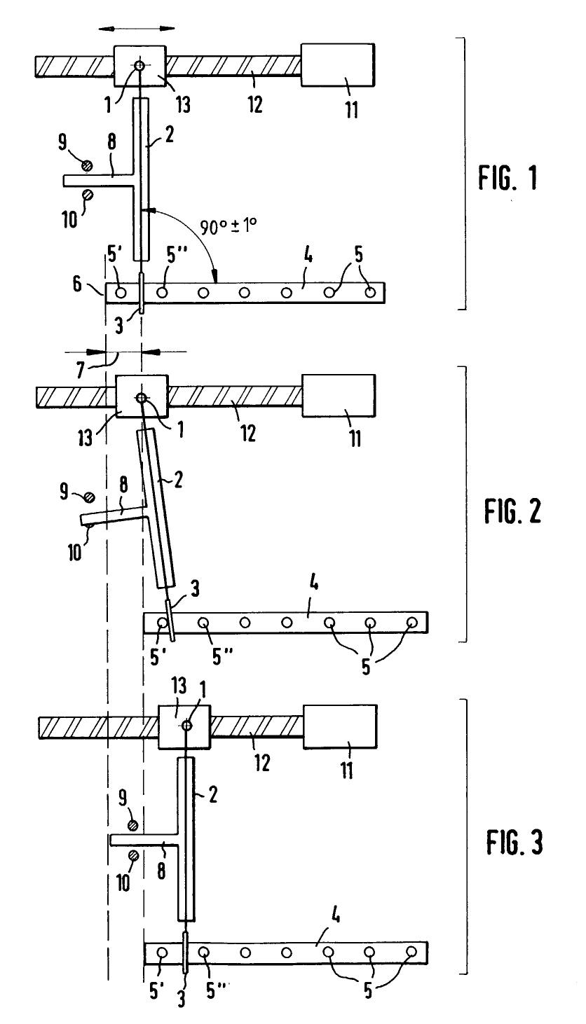

FIG. 1 shows a diagrammatic representation of the swinging suspension of a cutting knife at a carriage, which can be moved transversely to the cutting direction, in the ideal cutting position with the pendulum hanging perpendicularly downward,

FIG. 2 shows the arrangement of FIG. 1 with the pendulum in a position, in which the inclination exceeds the specified value and

FIG. 3 shows the arrangement after the carriage has been shifted in the direction of the deflection of the pendulum in order to counteract this deflection.

The Figures show the seat 2, which is suspended so that it can swing about an axis of rotation 1 and to which the cutting device 3, for example, a heated knife, is attached. The corded belt material 4 with the inserts 5 contained therein, that is, nylon or steel yarns, varies with respect to the position of its side edges 6, which are to be trimmed, within a range 7, which can be more than 5 mm and less than 25 mm. This leads to deflections of the swinging suspension of the seat 2, as indicated in FIG. 2. A cross arm 8, which is fastened to the swinging suspension of the seat 2 and protrudes between two sensors 9 and 10, arrives in an overlapping position with the lower sensor 10. This causes a servomotor 11 to start, which rotates a ball screw 12, on which a carriage 13, containing the axis of rotation 1, is seated, in the direction so that the carriage 13 is shifted to the right, that is, in the direction of deflection of the swinging suspension, so that it reaches the position of FIG. 3, in which, in spite of the greatly deviating side edge of the cord material, which is to be trimmed, the cutting device 3, hanging essentially vertically, lies exactly in the middle between the identical inserts 5′ and 5″. The distances between the sensors preferably are adjusted so that an ideal setting of the cutting unit with a 90°±1° angle to the corded material is assured at all times.

1. A device for trimming edges of belt materials containing inserts, especially nylon or steel corded belts, by cutting off an edge region of the belt material with a cutting device, which engages the belt material between the inserts, extending in the longitudinal direction (cutting direction) of the belt and is held in a seat, suspended so that it can swivel at a framework transversely to the conveying direction, corresponding to the longitudinal direction of the belt, of the belt material passed by it, wherein the axis of rotation (1) of the swinging suspension is disposed at a carriage (13), which can be moved by a motor transversely to the plane of swiveling and a device is provided, which detects the deflection of the pendulum and, when a specified value is exceeded, causes the carriage (13) to move in the direction of deflection.

2. The device of claim 1, wherein a cross arm (8), engaging between two adjustable sensors (9, 10), is fastened to the swinging suspension.

3. The device of claims 1 or 2, wherein the carriage (13) is seated on a ball screw (12), which can be driven in both directions by a servomotor (11).
